(19) United States
(12) Patent Application Publication
(10) Pub. No.: US 2025/0267451 A1
(43) Pub. Date: Aug. 21, 2025

(54) MESH RADIO COMMUNICATION DEVICE

(71) Applicant: Red Research Group, LLC, Southern Pines, NC (US)

(72) Inventors: Amber M. Gagliardo, Aberdeen, NC (US); Nash Patrick Flint, Aberdeen, NC (US)

(21) Appl. No.: 19/054,146

(22) Filed: Feb. 14, 2025

Related U.S. Application Data
(60) Provisional application No. 63/553,803, filed on Feb. 15, 2024.

(51) Int. Cl. H04W 12/02; H04L 67/12; H04W 12/06; H04W 84/18

(52) U.S. Cl. CPC H04W 12/02; H04L 67/12; H04W 12/06; H04W 84/18

(57) ABSTRACT

A mesh radio communication system for discreet messaging in remote environments. The mesh radio communication system includes a mesh radio communication device, a mesh network, and a remote device. The mesh radio communication device enables hidden messaging functionality of the remote device for transmitting and receiving messaging data via the mesh network.

### CROSS-REFERENCE TO RELATED APPLICATIONS

This application is related to and claims priority to U.S. provisional patent application No. 63/553,803, filed on Feb. 15, 2024, the entire contents of which is incorporated by reference herein in its entirety.

### BACKGROUND

Communication devices in remote environments can use Low Power Wide Area (LPWA) to communicate with other communication devices. LPWA technology includes a data link layer protocol that provides low power network connectivity for battery-powered devices. These battery-powered communication devices are used in harsh environments (e.g., military operations) and are critical for survival. Typically, in these harsh environments, sensitive communications are transmitted using these battery-powered communication devices. The security of these sensitive communications is critical for survival of operators.

### FIELD OF THE INVENTION

The present invention is generally directed to mesh radio communication systems and devices, more specifically to mesh radio communication systems and devices designed for discreet messaging.

### DESCRIPTION OF RELATED ART

Current mesh radio communication devices provide various security measures to protect the transmission of messages including sensitive information over a mesh network. The sensitive information should not be shared outside of a targeted recipient. However, mesh radio communication devices fail to provide local security measures that protect messaging functionality from unintended users. Therefore, there is a need for a mesh radio communication device that protects and enables sensitive communications in remote environments.

### BRIEF SUMMARY

In some embodiments, a mesh radio communication system is disclosed. The mesh radio communication system includes a mesh radio communication device including a radio housing, a printed circuit board assembly (PCBA), at least two antennas, at least two radio modules, and a microcontroller. The microcontroller includes firmware to maintain a mesh network. The at least two antennas are operable for dual frequencies. For example and without limitation, the mesh radio communication device is operable to transmit and receive data at each frequency of the dual frequencies. The at least two radio modules include at least two long range (LoRa) radio modules. The mesh radio communication device is operable to send and receive data (e.g., messages) over dual LoRa radio frequencies.

In some embodiments, a mesh radio communication system including a plurality of remote devices, at least one mesh network, and at least one mesh radio communication device is disclosed. The mesh network enables network communication between the plurality of remote devices. The mesh radio communication system is designed to prevent each remote device of the plurality of remote devices from receiving and viewing the messages transmitted over the mesh network unless the remote device includes a network node to decrypt the message. For example, and without limitation, if a user is in possession of a radio but not a corresponding messaging application, then the user will be unable to view message on another remote device. For further example, and without limitation, if a user is in possession of a remote device (e.g., Android) but not in possession and connected to a radio, then the messaging application will not receive messages. In some embodiments, the network congestion is controlled using Carrier Sense Multiple Access with Collision Avoidance (CSMA/CA).

In some embodiments, a mesh radio communication device including firmware encrypted using advanced encryption standard (AES) 256 is disclosed. Messages transmitted by the mesh radio communication device are encrypted using AES 128 and include private keys. For example, and without limitation, the private keys are encrypted and stored on the mesh radio communication device. The private keys are used to decrypt received messages with AES CTR with an initialization vector (IV). For further example, and without limitation, in some embodiments, all nodes on a mesh network have the same private key. In some embodiments, at least one private key is changeable via user input received via the mesh radio communication device and/or a corresponding messaging application.

In some embodiments, the mesh radio communication system includes a plurality of software applications that are interactable via an interface of a remote device. For example, and without limitation, in some embodiments, the plurality of software applications includes network dependent shell software applications. The shell software applications can include a tip calculator and a note taking application. The tip calculator may be associated with a first mesh network. The note taking application may be associated with a second mesh network that is separate from the first mesh network. Advantageously, this allows different users to have different versions of shell software application to help further abstract the mesh networks from each other. Additionally, if one shell software application is discovered, then the other covert mesh networks would still remain protected and confidential. For example, and without limitation, in some embodiments, the shell messaging application is dependent on a user, a network, a geographic location, and/or a work environment.

In some embodiments, the mesh radio communication system includes a LoRa mesh network including a plurality of mesh radio communication devices and a plurality of mesh networks. The LoRa mesh network is designed to prevent nodes from one mesh network from receiving messages from a separate mesh network node. The nodes are only interchangeable within the same mesh network. Advantageously, users send messages to other nodes without a public signature and in areas without other network signals (e.g., cellular). In some embodiments, the mesh network radio communication device further includes node to node communication, is operable for global positioning system (GPS) location tracking, to recognize that an end node received a message, and to generate an alert or similar feedback if the message was not successfully received.

In some embodiments, a mesh radio communication system is disclosed. The mesh radio communication system includes at least one remote device, a mesh network, and at least one mesh radio communication device. The mesh radio communication device is designed to connect (e.g., wireless or wired) to the at least one remote device. Once connected to the at least one remote device, the at least one mesh radio communication device is designed to undergo security protocols. Once verified, the at least one mesh radio communication device is operable to connect the at least one remote device to the mesh network. Via an interactable application on the at least one remote device, the at least one remote device is operable to receive user input (e.g., messaging data) and send the user input to one or more remote devices connected via the mesh network. The mesh network includes a control module (e.g., routine management) designed to optimize the transmission of the user input. In some embodiments, the mesh radio communication system is designed for flood mesh routing. For example, and without limitation, in some embodiments, each node is unaware of the quantity of nodes that also receive a message.

In at least one embodiment of the present disclosure, a mesh radio communication system is disclosed. The mesh radio communication system may include at least one remote device including an interactable interface and at least one software application. The mesh radio communication system may further include at least one mesh network and at least one mesh radio communication device including at least one processor and at least one antenna. The at least one remote device and the at least one mesh radio communication device can be operable for wired communication. Once the at least one mesh radio communication device and the at least one remote device are in wired communication, the at least one remote device can validate the at least one mesh radio communication device. One the at least one remote device validates the at least one mesh radio communication device, the at least one processor can modify a function of the at least one software application.

In some embodiments of the present disclosure, the at least one software application can include a visual identifier and a function corresponding to the visual identifier. Once the at least one mesh radio communication device is validated, the at least one remote device can modify the visual identifier of the at least one software application. In some embodiments, the at least one mesh radio communication device can connect the at least one remote device to the at least one mesh network. The at least one software application may include messaging functionality. The mesh radio communication system may be designed to remove data corresponding to the at least one software application from a memory of the at least one mesh radio communication device when the at least one mesh radio communication device disconnects from the at least one remote device. The at least one processor may change the visual identifier and functionality of the at least one software application when the at least one mesh radio communication device disconnects from the at least one remote device. In some embodiments, a software driver of the at least one remote device can initiate a connection between the at least one software application and the at least one mesh network. The at least one mesh radio communication device can initiate a secure handshake to connect the at least one software application and the at least one remote device. The at least one mesh radio communication device can modify at least one setting of the at least one mesh network. The mesh network setting may include a number of mesh networks and a number of nodes corresponding to a mesh network. The at least one mesh radio communication device may include a base and a lid. The base may include a channel to receive the lid. When the lid is inserted into the channel, the lid is flush against an upper edge of the base.

In some embodiments of the present disclosure, a mesh radio communication system is disclosed. The mesh radio communication system may include at least one remote device, at least one mesh network, and/or at least one mesh radio communication device. The at least one remote device can include an interactable interface, a processor, and at least one software application. The at least one mesh radio communication device can include at least one processor and at least one antenna. The at least one software application may include a visual identifier and a corresponding function. The at least one remote device and the at least one mesh radio communication device can be operable for wired communication. When the at least one mesh radio communication device and the at least one remote device are in wired communication, the at least one remote device can validate the at least one mesh radio communication device via a security protocol. Once the at least one remote device validates the at least one mesh radio communication device, the at least one processor of the at least one emote device can modify a function of the at least one software application. After the at least one remote device modifies the at least one software application, the at least one software application can send and receive messaging data via the at least one mesh network.

In some embodiments of the present disclosure, once the at least one mesh radio communication device is validated, the at least one processor of the at least one remote device can modify the visual identifier of the at least one software application. When the wired connection between the at least one mesh radio communication device and the at least one remote device is disconnected, the visual identifier of the at least one software application can revert back to an original appearance. In some embodiments, when the wired connection between the at least one mesh radio communication device and the at least one remote device is disconnected, the at least one software application cannot send messages via the at least one mesh network. In some embodiments, when the at least one mesh radio communication device is disconnected from the at least one remote device, software application data is removed from a memory of the at least one mesh radio communication device.

In some embodiments, the at least one mesh network includes at least four nodes. The at least four nodes can include a first node, a second node, a third node, and a fourth node. The first node is a source node for messaging data. The third node is a targeted recipient of the messaging data. The messaging data can be transmitted from the first node to the second node and from the second node to the third node. The third node can transmit the messaging data back to the first node via the third node.

In some embodiments, after the wired connection between the at least one mesh radio communication device and the at least one remote device is established, a software driver of the at least one remote device can initiate a connection between the at least one software application and the mesh network. The at least one mesh radio communication device can initiate a secure handshake to connect the at least one remote device and the at least one mesh network.

In some embodiments of the present disclosure, a mesh radio communication system is disclosed. The mesh radio communication system may include at least one remote device, at least one mesh network, and at least one mesh radio communication device. The at least one remote device includes an interactable interface, a processor, and at least one software application. The at least one mesh radio communication device can include at least one processor and at least one antenna. The at least one software application may include a visual identifier and a corresponding function. The at least one remote device and the at least one mesh radio communication device can be operable for wired communication. Once the at least one mesh radio communication device and the at least one remote device are in wired communication, the at least one remote device initiates a protocol for validating the at least one mesh radio communication device. The at least one mesh radio communication device can authenticate an identity of the at least one software application. Once the at least one remote device validates the at least one mesh radio communication device and the at least one mesh radio communication device authenticates an identity of the at least one software application, the at least one processor can modify a function of the at least one software application to include sending and receiving messaging data via the at least one mesh network.

In some embodiments, the at least one mesh radio communication device authenticates the identity of the at least one software application using at least one private key.

### BRIEF DESCRIPTION OF THE SEVERAL VIEWS OF THE DRAWINGS

The embodiments illustrated, described, and discussed herein are illustrative of the present invention. As these embodiments of the present invention are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates an exploded view of a mesh radio communication device according to at least one embodiment of the present disclosure.

FIG. 2 illustrates a side perspective view of a mesh radio communication device according to at least one embodiment of the present disclosure.

FIG. 3 illustrates a schematic diagram of a mesh radio communication system according to at least one embodiment of the present disclosure.

FIG. 4 illustrates a schematic diagram of a mesh radio communication system according to at least one embodiment of the present disclosure.

FIG. 5 illustrates a schematic diagram of a mesh radio communication system according to at least one embodiment of the present disclosure.

FIG. 6 illustrates a schematic diagram of server of a mesh radio communication system according to at least one embodiment of the present disclosure.

FIG. 7 illustrates a schematic diagram of a computer of a mesh radio communication system according to at least one embodiment of the present disclosure.

FIG. 8 illustrates a schematic diagram of mobile device of a mesh radio communication system according to at least one embodiment of the present disclosure.

FIG. 9 illustrates a schematic diagram of an IoT device of a mesh radio communication system according to at least one embodiment of the present disclosure.

### DETAILED DESCRIPTION

For the purposes of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

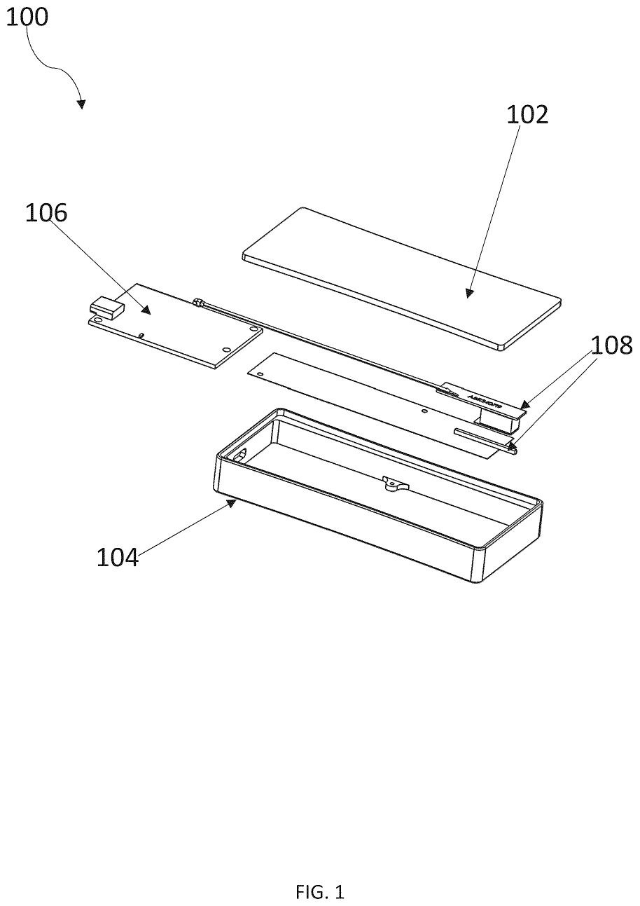

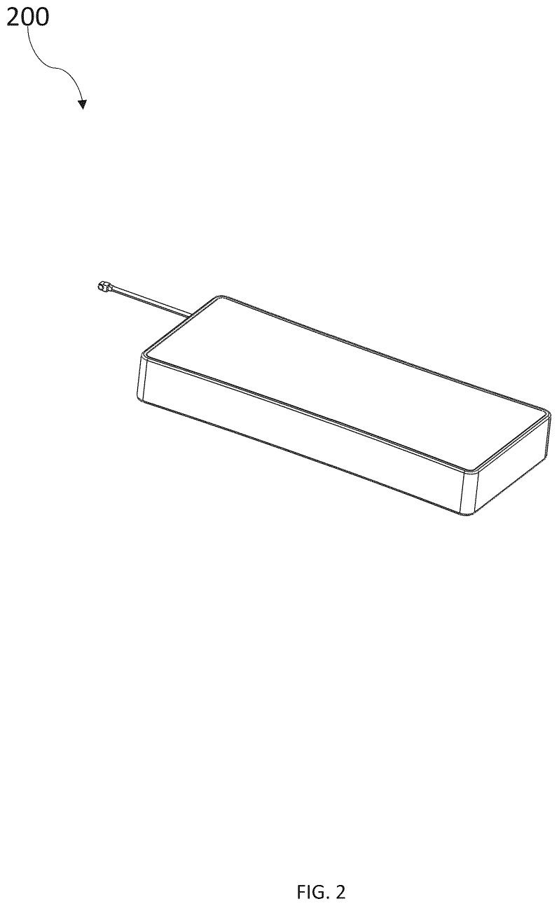

In some embodiments, a mesh radio communication system including a mesh radio communication device, a mesh network, and at least one remote device is disclosed. FIG. 1 illustrates an exploded view of a mesh radio communication device according to at least one embodiment. The mesh radio communication device 100 includes an enclosure lid 102, an enclosure base 104, at least one printed circuit board assembly 106, and a plurality of antennas 108. FIG. 2 illustrates a side perspective view of a mesh radio communication device according to at least one embodiment. In some embodiments, the enclosure lid attaches to the base via an attachment component. For example, and without limitation, the attachment component includes double-sided tape. The enclosure base receives the enclosure lid via an outside edge that results in the enclosure lid being flush against an upper edge of the enclosure base.

In some embodiments, the mesh radio communication device is operable for wired connection to at least one remote device. For example, and without limitation, the mesh radio communication device includes at least one port operable to receive a universal serial bus (USB)-A connector, a USB-B connector, a USB-C connector, a mini-USB, and/or a micro-USB connector. In some embodiments, the mesh radio communication device is operable to receive a network connector including but not limited to a RJ11 and an RJ45 connector.

The at least one printed circuit board assembly includes at least one processor and memory. The at least one processor is communicatively coupled to the memory. The at least one processor includes, but is not limited to, at least one microcontroller designed to manage encryption, transmission, repeatability, and scalability of the mesh network. For example, and without limitation, the mesh network is dynamically scaled. Each node is designed to repeat messages once. When a new device is added to the mesh network, the new device is operable to repeat messages. Advantageously, the source node of a message confirms delivery of messaging data when the source nodes receive the message from another node within the mesh network.

The at least one remote device includes memory and at least one processor. The memory includes software instructions for a software application. In some embodiments, in response to the software instructions, the at least one processor generates a messaging application operable for network communication with the mesh network. The software instructions further include reconfiguring the appearance of an icon corresponding to the messaging application. Advantageously, each shell messaging application includes software instructions to match the shell application appearance (e.g., calculator) with corresponding functionality. Therefore, the shell messaging application will perform a function matching the shell messaging application appearance when the remote device is not connected with a mesh radio communication device. The messaging application is designed to send and receive messaging information from the mesh network. The processor is any controller, microcontroller, or microprocessor that is capable of processing program instructions.

The at least two antennas are operable to send information and/or receive information. The at least two antennas are designed for wireless communications including but not limited to LoRa, radiofrequency, Bluetooth, ZigBee, near-field communication (NFC) and other similar standards. The remote device is any device capable of running mobile application and connecting to the mesh radio communication device. For example, and without limitation, the remote device includes an Android phone, an Apple iPhone, a Samsung Galaxy, a tablet, and other similar devices.

For further example, and without limitation, the messaging application can be disguised as a functional tip calculator. The mesh radio communication device is operable for wire connection via a USB-C port to at least one remote device. After detecting a wired connection with the mesh radio communication device, the remote device confirms and validates one or more software drivers of the connected microcontroller of the mesh radio communication device. If the one or more software drivers match a targeted computer chip (e.g., microchip or silicon chip corresponding to a mesh radio communication device), then the remote device is operable to generate a user prompt to connect to the mesh network. After receiving user input (e.g., pressing and/or selecting connect via a user interface) the at least one remote device is operable to initiate a handshake protocol between the mesh radio communication device and the remote device. If the handshake protocol is successfully passed, then the messaging function is enabled and the messaging application is operable to send and receive messages. For example, and without limitation, the messaging application transmits an application key to the mesh radio communication device. The mesh radio communication device validates the application key. If the application key is invalid, then access to the messaging application is denied.

For further example, and without limitation, the remote device includes an Android device and the messaging application is an Android application. Once the Android device is connected to the mesh radio communication device, a software driver of the Android device initiates a connection between the messaging application and the mesh network. The mesh radio communication device includes a connect button (e.g., physical or virtual) that initiates a secure handshake between the mesh radio communication device and the Android device. Once connected, the messaging application and the remote device are interdependent and cannot be used without the other. After corresponding security measures are passed, the messaging features of the messaging application are unlocked and the remote device is operable to transmit and receive messages via the radio communication device. In some embodiments, the messaging application is functional only with a mesh radio communication device that validates the messaging application key during a handshake. Advantageously, this maintains separation between mesh networks and the messaging application.

In some embodiments, local messaging data is destroyed upon disconnection of the mesh radio communication device. After disconnection, the messaging application is operable to automatically transform into a shell software application. The messages sent prior to disconnection are still received on a receiving node. The sent messages include identification of the sending node. The mesh network is designed to transmit messages to at least one other node on the mesh network. If the security measure is failed, then the application remains a tip calculator.

In some embodiments, the mesh radio communication system includes a mesh network configuration tool. The mesh network configuration tool enables customization of a node. For example, and without limitation, if a mesh network includes ten nodes, the mesh network configuration tool is operable to reconfigure the nodes into two mesh networks, each with five nodes. The network configuration tool is further operable to configure the nodes at a desired time. For example, on a first day, the network configuration tool is operable to create two networks with five nodes, then, on the following day, the network configuration tool is further operable to create five mesh networks with two nodes. For further example, and without configuration, the configuration tool enables network size configuration and encrypting application keys. The configuration tool enables control over radio features including frequency and timing. In some embodiments, the configuration tool is operable to enable and disable a beacon feature of a node.

In some embodiments, the mesh radio communication system is designed for long range (LoRa) communications. LoRa technology transmits data at a longer range than WiFi, Bluetooth or ZigBee and does not require connection to a cellular network. Advantageously, this enables the mesh radio communication system to be used in harsh environments such as military operations. LoRa technology can be used on sub-gigahertz frequency bands, including, but not limited to 915 MHZ, 868 MHZ, and 433 MHZ. In some embodiments, LoRa technology can be used at frequencies greater than a gigahertz.

In some embodiments, the mesh radio can be used for Low Power Wide Area (LPWA) networks. In some embodiments, the mesh radio includes a long range wide area network (LoRaWAN). The LoRaWAN is a media access control (MAC) layer that defines how devices utilize LoRa hardware (e.g., transmission timing and format). In some embodiments, the mesh radio communication system is operable to transmit signals over about 10 kilometers. In some embodiments, the LoRaWAN Network is operable to communicate in interior environments (e.g., inside a building).

A LoRaWAN network includes at least one gateway, at least one end-device, and a network server. The at least one end device collects data and actuates and generates LoRaWAN packets. The gateway receives the LoRaWAN packets and forwards them to the Network server. The gateway does not decode the packets or know the content in the data packets. The network server includes a network layer, an application layer, and a join layer. The network layer manages verification of end-devices addresses, packet acknowledgement, frame count, and responds to end-device requests. The network layer also forwards messages to the application layer and join layer and manages downlink message queue. The application layer forwards all packets received from the network layer to a specific application. The join layer is responsible for authentication process and generating and distributing authentication keys. For example, and not limitation, the authentication methods includes Activation by Personalization and Over-The-Air Activation. In some embodiments, the LoRaWAN network determines a location of at least one end device using triangulation. Alternative or additionally, a global positioning system is used to determine a location.

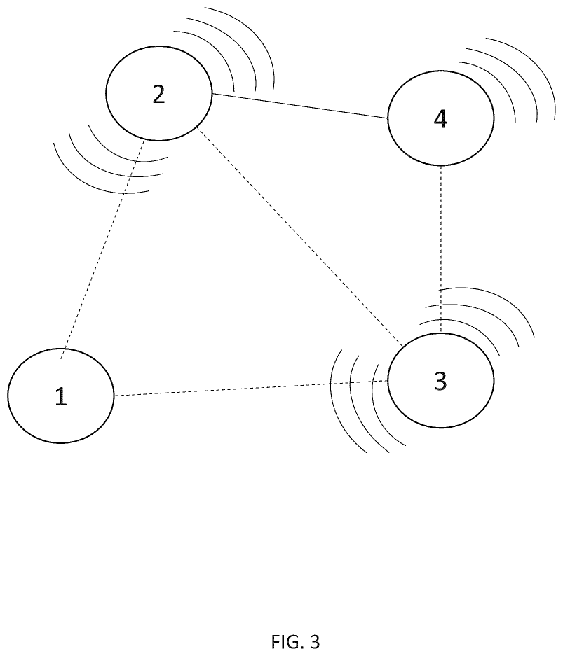

FIG. 3 illustrates a schematic diagram of a mesh radio communication system according to at least one embodiment. The mesh radio communication system includes a plurality of nodes. In some embodiments, as shown in FIG. 3, the mesh radio communication system includes at least four nodes including Node 1, Node 2, Node 3, and Node 4. For example, and without limitation, Node 1 detects that it is the origin of a message and does not display the message to a user. Nodes 2 and 3 do not re-display or re-transmit an identical message. Node 4 directly receives the message from Node 2. Node 4 detects the message from Node 3 is identical to the message from Node 2 and does not re-display the message to the user or re-transmit the message. Node 4 is operable to display the message to a second user for a corresponding device. In some embodiments, the nodes are designed to repeat and respond to data if a Cyclic Redundancy Check is passed. The nodes are designed to display a message only when messages are successfully decrypted.

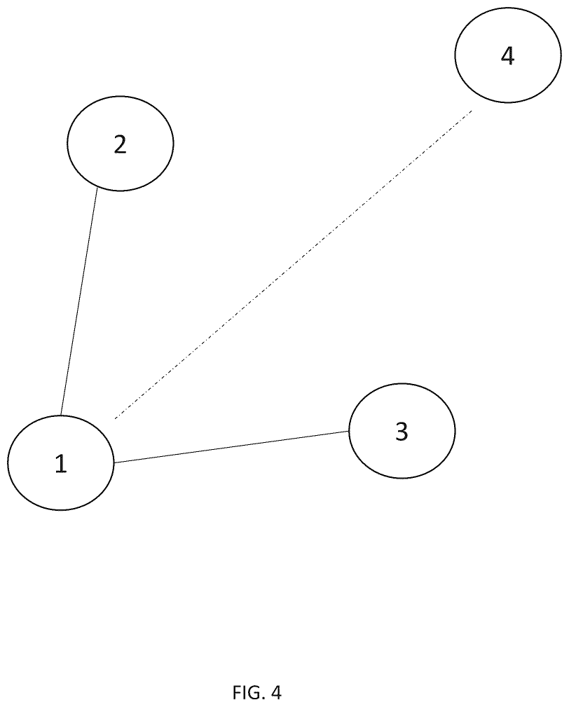

FIG. 4 illustrates a schematic diagram of a mesh radio communication system according to at least one embodiment. The mesh radio communication system includes a plurality of nodes. For example, and not limitation, the plurality of nodes includes a first node (Node 1), a second node (Node 2), a third node (Node 3), and a fourth node (Node 4). Node 1 is the source of a message and is in direct network connection to Node 2 and Node 3. Both Node 2 and Node 3 are designed to display the message to a corresponding user. Node 4 is out of range of the original message.

In some embodiments, the mesh radio communication device is operable to connect to at least one remote device. The at least one remote device includes, but is not limited to, a cell phone, a computer, a laptop, a vehicle, and other similar remote devices. In some embodiments, the remote device is operable to send and receive at least one command and/or at least one setting. The at least one command and/or at least one setting includes spreading factor (SF), bandwidth (BW), coding rate (CR), Cyclic Redundancy Check (CRC), sync words, frequency, gain, and power.

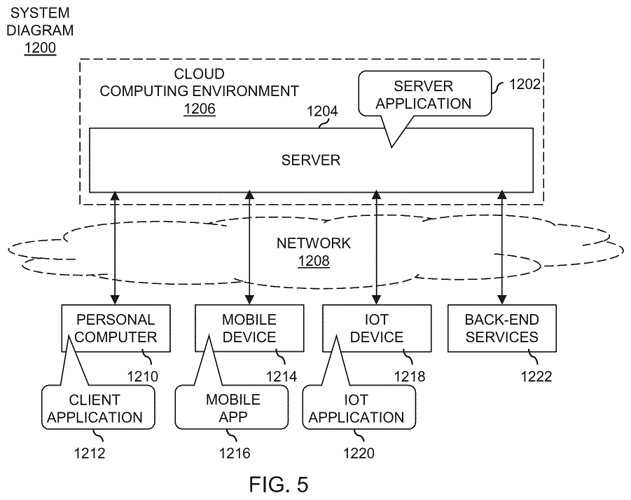

FIG. 5 depicts a system diagram 1200 illustrating a client/server architecture in accordance with embodiments of the present disclosure. The server application 1202 is configured to provide a video application and mobile application for a smart multi-resident community management system. A server application 1202 is hosted on a remote server 1204 within a cloud computing environment 1206. The server application 1202 is provided on a non-transitory computer-readable medium including a plurality of machine-readable instructions, which when executed by one or more processors of the server 1204, are adapted to cause the server 1204 to generate the video platform and mobile application.

The server application 1202 is configured to communicate over a network 1208. In a preferred embodiment, the network 1208 is the Internet. In other embodiments, the network 1208 may be restricted to a private local area network (LAN) and/or private wide area network (WAN). The network 1208 provides connectivity with a plurality of client devices including a personal computer 1210 hosting a client application 1212, a mobile device 1214 hosting a mobile app 1216. The network 1208 also provides connectivity for an Internet-Of-Things (IoT) device 1218 hosting an IoT application 1220 and to back-end services 1222. Advantageously, the back-end services are operable to communicate with third-party application programming interfaces (APIs) to either provide or receive data that can be used by the system to provide recommendations. Third-party applications provide algorithms for analysis of data. The back-end services may provide data gathered within the mesh radio communication system through the third-party APIs and receives results from the algorithms provided back to the back-end services to provide further recommendations or take further actions within the mesh radio communication system.

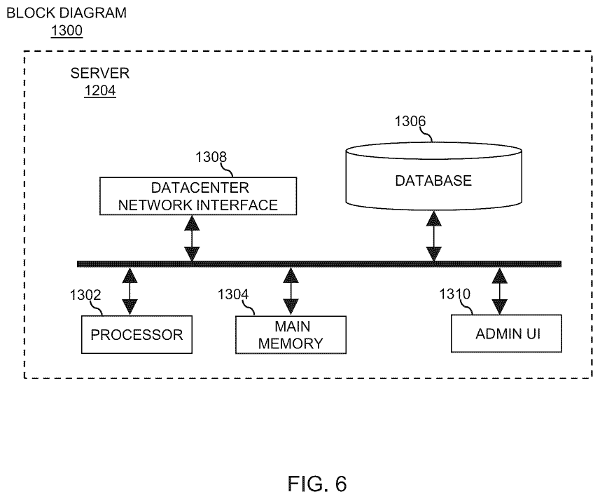

FIG. 6 depicts a block diagram 1300 of the server 1204 of FIG. 5 for hosting at least a portion of the server application 1202 of FIG. 5 in accordance with embodiments of the present disclosure. The server 1204 may be any of the hardware servers referenced in this disclosure. The server 1204 may include at least one of a processor 1302, a main memory 1304, a database 1306, a datacenter network interface 1308, and an administration user interface (UI) 1310. The server 1204 may be configured to host one or more virtualized servers. For example, the virtual server may be an Ubuntu® server or the like. The server 1204 may also be configured to host a virtual container. For example, the virtual server may be the DOCKER® virtual server or the like. In some embodiments, the virtual server and or virtual container may be distributed over a plurality of hardware servers using hypervisor technology.

The processor 1302 may be a multi-core server class processor suitable for hardware virtualization. The processor 1302 may support at least a 64-bit architecture and a single instruction multiple data (SIMD) instruction set. The memory 1304 may include a combination of volatile memory (e.g., random access memory) and non-volatile memory (e.g., flash memory). The database 1306 may include one or more hard drives.

The datacenter network interface 1308 may provide one or more high-speed communication ports to the data center switches, routers, and/or network storage appliances. The datacenter network interface may include high-speed optical Ethernet, InfiniBand (IB), Internet Small Computer System Interface iSCSI, and/or Fibre Channel interfaces. The administration UI may support local and/or remote configuration of the server by a data center administrator.

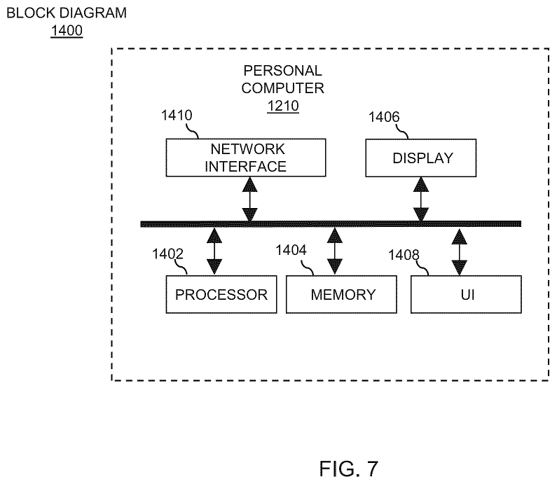

FIG. 7 depicts a block diagram 1400 of the personal computer 1210 of FIG. 5 in accordance with embodiments of the present disclosure. The personal computer 1210 may be any of the devices referenced in this disclosure. The personal computer 1210 may include at least a processor 1402, a memory 1404, a display 1406, a user interface (UI) 1408, and a network interface 1410. The personal computer 1210 may include an operating system to run a web browser and/or the client application 1212 shown in FIG. 5 The operating system (OS) may be a Windows® OS, a Macintosh® OS, or a Linux® OS. The memory 1404 may include a combination of volatile memory (e.g., random access memory) and non-volatile memory (e.g., solid state drive and/or hard drives).

The network interface 1410 may be a wired Ethernet interface or a Wi-Fi interface. The personal computer 1210 may be configured to access remote memory (e.g., network storage and/or cloud storage) via the network interface 1410. The UI 1408 may include a keyboard, and a pointing device (e.g., mouse). The display 1406 may be an external display (e.g., computer monitor) or internal display (e.g., laptop). In some embodiments, the personal computer 1210 may be a smart TV. In other embodiments, the display 1406 may include a holographic projector.

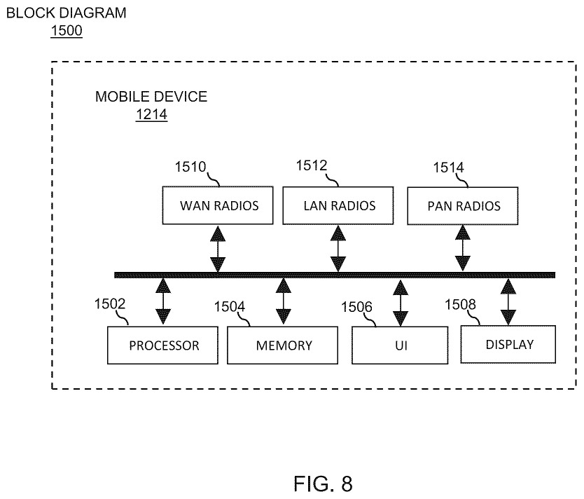

FIG. 8 depicts a block diagram 1500 of the mobile device 1214 of FIG. 5 in accordance with embodiments of the present disclosure. The mobile device 1214 may be any of the remote devices referenced in this disclosure. The mobile device 1214 may include an operating system to run a web browser and/or the mobile app 1216 shown in FIG. 5. The mobile device 1214 may include at least a processor 1502, a memory 1504, a UI 1506, a display 1508, WAN radios 1510, LAN radios 1512, and personal area network (PAN) radios 1514. In some embodiments the mobile device 1214 may be an iPhone® or an iPad®, using iOS® as an OS. In other embodiments the mobile device 1214 may be a mobile terminal including Android® OS, BlackBerry® OS, Chrome® OS, Windows Phone® OS, or the like.

In some embodiments, the processor 1502 may be a mobile processor such as the Qualcomm® Snapdragon™ mobile processor. The memory 1504 may include a combination of volatile memory (e.g., random access memory) and non-volatile memory (e.g., flash memory). The memory 1504 may be partially integrated with the processor 1502. The UI 1506 and display 1508 may be integrated such as a touchpad display. The WAN radios 1510 may include 2G, 3G, 4G, and/or 5G technologies. The LAN radios 1512 may include Wi-Fi technologies such as 802.11a, 802.11b/g/n, and/or 802.11ac circuitry. The PAN radios 1514 may include Bluetooth® technologies.

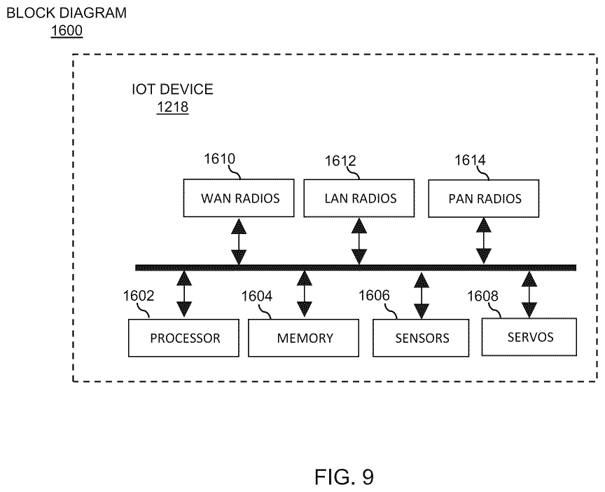

FIG. 9 depicts a block diagram 1600 of the IoT device 1218 of FIG. 5 in accordance with embodiments of the present disclosure. The IoT device 1218 may be any of the remote devices referenced in this disclosure. The IoT device 1218 includes a processor 1602, a memory 1604, sensors 1606, servos 1608, WAN radios 1610, LAN radios 1612, and PAN radios 1614. The processor 1602, a memory 1604, WAN radios 1610, LAN radios 1612, and PAN radios 1614 may be of similar design to the processor 1502, a memory 1504, WAN radios 1510, LAN radios 1512, and PAN radios 1514 of the mobile device 1214 of FIG. 8. The sensors 1606 and servos 1608 may include any applicable components related to IoT devices such as a monitoring device, an autonomous vehicle, a smart appliance, a medical device, a virtual reality device, an augmented reality device, or the like.

Any combination of one or more computer-readable medium(s) may be utilized. The computer-readable medium may be a computer readable signal medium or a computer-readable storage medium (including, but not limited to, non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer readable storage medium and that can communicate, propagate, or transport a program for use by or in connection with an instruction execution system, apparatus, or device.

In one embodiment, the mesh radio communication system includes a cloud-based network for distributed communication via a wireless communication antenna and processing by at least one mobile communication computing device. In another embodiment, the system is a virtualized computing system capable of executing any or all aspects of software and/or application components presented herein on computing devices. In certain aspects, the computer system may be implemented using hardware or a combination of software and hardware, either in a dedicated computing device, or integrated into another entity, or distributed across multiple entities or computing devices.

By way of example, and not limitation, the computing devices are intended to represent various forms of digital computers and mobile devices, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document.

In one embodiment, the computing device includes components such as a processor, a system memory having a random-access memory (RAM) and a read-only memory (ROM), an I2C sensor, and a system bus that couples the memory to the processor. In another embodiment, the computing device may additionally include components such as a storage device for storing the operating system and one or more application programs, a network interface unit, and/or an input/output controller. Each of the components may be coupled to each other through at least one bus. The input/output controller may receive and process input from, or provide output to, a number of other devices, including, but not limited to, alphanumeric input devices, mice, electronic styluses, display units, touch screens, signal generation devices (e.g., speakers), or printers.

By way of example, and not limitation, the processor may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another embodiment, multiple processors and/or multiple buses may be used, as appropriate, along with multiple memories of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function. According to various embodiments, the computer system may operate in a networked environment using logical connections to local and/or remote computing devices through a network. A computing device may connect to a network through a network interface unit connected to a bus. Computing devices may communicate communication media through wired networks, direct-wired connections or wirelessly, such as acoustic, RF, or infrared, through an antenna in communication with the network antenna and the network interface unit, which may include digital signal processing circuitry when necessary. The network interface unit may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer readable medium may include the memory, the processor, and/or the storage media and may be a single medium or multiple media (e.g., a centralized or distributed computer system) that store the one or more sets of instructions. Non-transitory computer readable media includes all computer readable media, with the sole exception being a transitory, propagating signal per se. The instructions may further be transmitted or received over the network via the network interface unit as communication media, which may include a modulated data signal such as a carrier wave or other transport mechanism and includes any delivery media. The term “modulated data signal” means a signal that has one or more of its characteristics changed or set in a manner as to encode information in the signal.

Storage devices and memory include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system.

The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A mesh radio communication system comprising:
at least one remote device including an interactable interface and at least one software application;
at least one mesh network; and
at least one mesh radio communication device including at least one processor and at least one antenna;
wherein the at least one remote device and the at least one mesh radio communication device are operable for wired communication;
wherein, once the at least one mesh radio communication device and the at least one remote device are in wired communication, the at least one remote device validates the at least one mesh radio communication device, and
wherein, once the at least one remote device validates the at least one mesh radio communication device, the at least one processor is operable to modify a function of the at least one software application.

2. The mesh radio communication system of claim 1, wherein, prior to validation of the at least one mesh radio communication device, the at least one software application includes a visual identifier, wherein the at least one software application is operable to perform a function corresponding to the visual identifier.

3. The mesh radio communication system of claim 2, wherein, when the at least one mesh radio communication device is validated, the at least one remote device is operable to modify the visual identifier of the at least one software application.

4. The mesh radio communication system of claim 3, wherein the at least one mesh radio communication device is operable to connect the at least one remote device to the at least one mesh network, wherein the at least one software application is operable to send and receive messaging data.

5. The mesh radio communication system of claim 1, wherein, when the at least one mesh radio communication device is disconnected from the at least one remote device, data corresponding to the at least one software application is removed from a memory of the at least one mesh radio communication device.

6. The mesh radio communication system of claim 2, wherein, when the at least one mesh radio communication device is disconnected from the at least one remote device, the at least one processor is operable to change the visual identifier of the at least one software application, wherein the at least one processor is further operable to change the functionality of the at least one software application.

7. The mesh radio communication system of claim 1, wherein a software driver of the at least one remote device initiates a connection between the at least one software application and the at least one mesh network, wherein the at least one mesh radio communication device initiates a secure handshake to connect the at least one software application and the at least one remote device.

8. The mesh radio communication system of claim 1, wherein the at least one mesh radio communication device is operable to modify at least one setting of the at least one mesh network, wherein the at least one setting includes a number of mesh networks and a number of nodes corresponding to a mesh network.

9. The mesh radio communication system of claim 1, wherein the at least one mesh radio communication device includes a base and a lid, wherein the base includes a channel to receive the lid, wherein, when the lid is inserted into the channel, the lid is flush against an upper edge of the base.

10. A mesh radio communication system comprising:
at least one remote device including an interactable interface, a processor, and at least one software application;
at least one mesh network; and
at least one mesh radio communication device including at least one processor and at least one antenna;
wherein the at least one software application includes a visual identifier and a corresponding function;
wherein the at least one remote device and the at least one mesh radio communication device are operable for wired communication;
wherein, once the at least one mesh radio communication device and the at least one remote device are in wired communication, the at least one remote device validates the at least one mesh radio communication device via a security protocol, and
wherein, once the at least one remote device validates the at least one mesh radio communication device, the at least one processor of the at least one remote device is operable to modify a function of the at least one software application, wherein, after the at least one remote device modifies the at least one software application, the at least one software application is operable to send and receive messaging data via the at least one mesh network.

11. The mesh radio communication system of claim 10, wherein, when the at least one mesh radio communication device is validated, the at least one processor of the at least one remote device is operable to modify the visual identifier of the at least one software application.

12. The mesh radio communication system of claim 11, wherein, when the wired connection between the at least one mesh radio communication device and the at least one remote device is disconnected, the visual identifier of the at least one software application reverts back to an original appearance.

13. The mesh radio communication system of claim 12, wherein, when the wired connection between the at least one mesh radio communication device and the at least one remote device is disconnected, the at least one software application cannot send messages via the at least one mesh network.

14. The mesh radio communication system of claim 10, wherein, when the at least one mesh radio communication device is disconnected from the at least one remote device, software application data is removed from a memory of the at least one mesh radio communication device.

15. The mesh radio communication system of claim 10, wherein the at least one mesh network includes at least four nodes, wherein the at least four nodes includes a first node, a second node, a third node, and a fourth node, wherein the first node is a source node for messaging data, wherein the third node is a targeted recipient of the messaging data, wherein the messaging data is transmitted from the first node to the second node, wherein the messaging data is transmitted from the second node to the third node, wherein the third node is operable to transmit the messaging data back to the first node via the third node.

16. The mesh radio communication system of claim 10, wherein, after the wired connection between the at least one mesh radio communication device and the at least one remote device is established, a software driver of the at least one remote device initiates a connection between the at least one software application and the mesh network, wherein the at least one mesh radio communication device initiates a secure handshake to connect the at least one remote device and the at least one mesh network.

17. A mesh radio communication system comprising:
at least one remote device including an interactable interface, a processor, and at least one software application;
at least one mesh network; and
at least one mesh radio communication device including at least one processor and at least one antenna;
wherein the at least one software application includes a visual identifier and a corresponding function;
wherein the at least one remote device and the at least one mesh radio communication device are operable for wired communication;
wherein, once the at least one mesh radio communication device and the at least one remote device are in wired communication, the at least one remote device initiates a protocol for validating the at least one mesh radio communication device, wherein the at least one mesh radio communication device authenticates an identify of the at least one software application;
wherein, once the at least one remote device validates the at least one mesh radio communication device and the at least one mesh radio communication device authenticates an identity of the at least one software application, the at least one processor of the at least one remote device is operable to modify a function of the at least one software application, wherein, after the at least one remote device modifies the at least one software application, the at least one software application is operable to send and receive messaging data via the at least one mesh network.

18. The mesh radio communication system of claim 17, wherein the at least one mesh radio communication device authenticates the identity of the at least one software application using at least one private key.
